(19) United States
(12) Patent Application Publication
(10) Pub. No.: US 2008/0080359 A1
(43) Pub. Date: Apr. 3, 2008

(54) Optical pickup unit and disk drive unit

(75) Inventors: Yuji Tamenori, Tokyo (JP); Mitsuhiro Ueno, Kanagawa (JP); Kazuhito Kurita, Kanagawa (JP); Tadami Nakamura, Saitama (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/898,256

(22) Filed: Sep. 11, 2007

(30) Foreign Application Priority Data
Sep. 28, 2006 (JP) 2006-265826

(51) Int. Cl. G11B 17/30

(52) U.S. Cl. 369/219.1

(57) ABSTRACT

An optical pickup unit, including: a base chassis; a disk table mounted to the base chassis for chucking an optical disk to be able to freely rotate; an optical pickup that records and/or reproduces an information signal with respect to the optical disk; a guide shaft supported by the base chassis, and guides the optical pickup to move in a diameter direction of the optical disk; and a pickup transfer mechanism including a lead screw supported parallel to the guide shaft and engaged with the optical pickup via a rack member, and a drive motor for rotate-driving the lead screw. In the optical pickup unit, the drive motor is disposed out of a projection area of, with respect to the base chassis, the optical disk chucked to the disk table.

### CROSS REFERENCES TO RELATED APPLICATIONS

The present invention contains subject matter related to Japanese Patent Application JP 2006-265826 filed in the Japanese Patent Office on Sep. 28, 2006, the entire contents of which being incorporated herein by reference.

### BACKGROUND OF THE INVENTION

1. Field of the Invention

The present invention relates to an optical pickup unit that records and/or reproduces an information signal with respect to a disk-shaped recording medium, and a disk drive unit including the optical pickup unit.

2. Description of the Related Art

A disk drive unit incorporated into a drive bay of a notebook or desktop personal computer is often of a so-called tray type, i.e., including a unit body shaped substantially like a rectangle, and a disk tray provided to be able to slide across the unit body. FIG. 14 shows a general disk drive unit 200 of such a type, which includes a unit body 201, a disk tray 202, and an optical pickup unit 203. The unit body 201 is configured by a pair of upper and lower halves being butt-coupled, and the disk tray 202 carries thereon an optical disk 207. The optical pickup unit 203 is mounted to the disk tray 202, and reproduces an information signal with respect to the optical disk 207 mounted on the disk tray.

The disk tray 202 is allowed to slide across the unit body 201. When the disk tray 202 is pulled out from the unit body 201 equipped to the body of a personal computer, a disk table 211 of the optical pickup unit 203 is exposed outside, and the optical disk 207 is chucked and ejected. Such a disk tray 202 is formed with a housing concave section 205 for accommodating therein the optical disk 207 by being enclosed by an-arc-shaped housing wall 204. From this housing concave section 205, a disk table 211 and an objective lens 221 of the optical pickup unit 203 are exposed. In the disk tray 202, the optical disk 207 is placed on the housing concave section 205, and is retained to be able to freely rotate by being chucked to the disk table 211 by a user.

The disk tray 202 is attached with the optical pickup unit 203 on the rear surface side of the housing concave section 205. When the optical pickup unit 203 is attached to the disk tray 202 as such, the disk table 211 and the objective lens 221 are exposed outside from an aperture portion formed to the housing concave section 205.

As shown in FIG. 15, the optical pickup unit 203 is configured to include a base chassis 210, the disk table 211, an optical pickup unit 212, a pickup transfer mechanism 213, and a pair of guide shafts 214 and 214. The base chassis 210 configures a unit body, and the disk table 211 is formed as a piece with the base chassis 210, and thereon, the optical disk 207 is placed. The optical pickup unit 212 records or reproduces an information signal with respect to the optical disk 207 disposed on the disk table 211. The pickup transfer mechanism 213 moves the optical pickup unit 212 across the diameter direction of the optical disk 207. The guide shafts 214 and 214 guide the movement of the optical pickup unit 212 by the pickup transfer mechanism 213.

The optical pickup unit 212 includes a pickup base 220. This pickup base 220 is provided with, at least, a light source such as semiconductor laser (not shown), the objective lens 221, a photodetector (not shown), and a drive system. The objective lens 221 makes light beams from the light source converge on a signal recording surface of the optical disk 207 for irradiation. The photodetector detects reflected lights from the recording surface of the optical disk 207. The drive system serves to drive the objective lens 221 in the directions of focusing and tracking of the optical disk 207. The optical pickup unit 212 is supported by the guide shafts 214 at both sides of the pickup base 220 in the longitudinal direction.

The optical pickup unit 212 is provided adjacent to one of the guide shafts 214, and is formed with a rack member 222, which is engaged with a lead screw 225 of the pickup transfer mechanism 213 serving to move the pickup base 220.

The optical pickup unit 212 is supposed by a pair of guide shafts 214 and 214 disposed to the base chassis 210. With supporting as such, the optical pickup unit 212 is guided to move in and out along the optical disk 207, and the objective lens 221 is opposed the signal recording surface of the optical disk 207.

The pickup transfer mechanism 213 is provided adjacent to one of the guide shafts 214, and moves the optical pickup unit 212 across the diameter direction of the optical disk 207. As shown in FIG. 15, such a pickup transfer mechanism 213 includes the lead screw 225 and a feed motor 226. The lead screw 225 is attached to the base chassis 210 across the diameter direction of the optical disk 207 to be adjacent and parallel to the guide shaft 214. The lead screw 225 is also engaged with the rack member 222. The feed motor 226 serves to rotate-drive the lead screw 225. The lead screw 225 is directly rotate-driven with the feed motor 226 attached to one end thereof, or is rotate-driven via a gear by being coupled with the feed motor 226 through one or more gears. With such a configuration, the lead screw 225 can move the pickup base 220 across the diameter direction of the optical disk 207 via the rack member 222.

As an example, refer to Patent Document 1 (JP-A-2004-234798).

### SUMMARY OF THE INVENTION

The issue here is that in the field of electronic equipment such as notebook personal computer, desktop personal computer, and disk player, the size and weight reductions have been the center of attention with the current functionality improvement of the electronic equipment. The further thickness reduction is also asked for disk drive units for mounting to the electronic equipment.

In the disk drive unit 200 described above, the space for the device body 201 is reduced due to the size reduction of the drive bay. With the resulting limited placement space, as shown in FIGS. 15 and 16, the feed motor 226 is disposed in the projection plane of the optical disk 207 with respect to the disk tray 202. The optical disk 207 is being chucked to the disk table 211.

The feed motor 226 is often a direct current (DC) motor and a stepping motor, and the current thickness thereof is 5 mm at the minimum, i.e., thicker than the thickness-reduced pickup base 220. Therefore, in the disk drive unit 200 as shown in FIG. 16, i.e., the feed motor 226 is disposed in the projection plane of the optical disk 207, the feed motor 226 resultantly increases the thickness of the optical pickup unit 203, which is previously defined to have a specific thickness needed for freely rotating the optical disk 207 chucked to the disk table 211. Such a thickness increase has hindered the attempt of thickness reduction of the optical pickup unit 203, and by extension, the thickness reductions of the disk tray 202 and the device body 201 have been also hindered thereby, i.e., the disk tray 202 is attached with the thickness-increased optical pickup unit 203, and the device body 201 carries therein the resulting thicker disk tray 202.

If an attempt of reducing the size of the feed motor 226 is made to achieve the thickness reduction for the optical pickup unit 203, the transfer torque is resultantly reduced, and thus the pickup base 220 cannot be transferred in a satisfactory manner.

It is thus desirable to provide a thickness-reduced optical pickup unit, and a disk drive unit reduced in thickness by using the thickness-reduced optical pickup unit.

According to an embodiment of the present invention, there is provided an optical pickup unit that includes: a base chassis; a disk table mounted to the base chassis for chucking an optical disk to be able to freely rotate; an optical pickup that records and/or reproduces an information signal with respect to the optical disk; a guide shaft supported by the base chassis, and guides the optical pickup to move in the diameter direction of the optical disk; and a pickup transfer mechanism including a lead screw supported parallel to the guide shaft and engaged with the optical pickup via a rack member, and a drive motor for rotate-driving the lead screw. In the optical pickup unit, the drive motor is disposed out of a projection area of, with respect to the base chassis, the optical disk chucked to the disk table.

According to another embodiment of the present invention, there is provided a disk drive unit that includes: a base chassis; a disk table mounted to the base chassis for chucking an optical disk to be able to freely rotate; an optical pickup that records and/or reproduces an information signal with respect to the optical disk; a guide shaft supported by the base chassis, and guides the optical pickup to move in the diameter direction of the optical disk; and a pickup transfer mechanism including a lead screw supported parallel to the guide shaft and engaged with the optical pickup via a rack member, and a drive motor for rotate-driving the lead screw. In the disk drive unit, the drive motor includes an optical pickup unit disposed out of a projection area of, with respect to the base chassis, the optical disk chucked to the disk table.

According to the optical pickup unit and the disk drive unit of the embodiments of the invention, the feed motor required to be thick to a certain extent is disposed outside of the projection plane of the optical disk. As such, the feed motor that has been the impediment to thickness reduction of the entire unit can be disposed at the upper portion of the base chassis, i.e., outside of the projection plane of the optical disk where the space is ample. This configuration accordingly shifts upward the lower limit of the optical pickup unit and that of the disk drive unit in its entirety so that the thickness reduction can be entirely achieved.

### BRIEF DESCRIPTION OF THE DRAWINGS

FIG. 1 is a perspective view of a notebook personal computer carrying therein a recording and/or reproduction device of an embodiment of the invention;

FIG. 2 is an exploded perspective view of the recording and/or reproduction device of an embodiment of the invention;

FIG. 3 is a perspective view of a disk tray;

FIG. 4 is a bottom view of the disk tray;

FIG. 5 is an exploded perspective view of an optical pickup unit of an embodiment of the invention;

FIG. 6 is a bottom view of a pickup base;

FIG. 7 is a perspective view of a motor bracket;

FIG. 8 is another perspective view of the motor bracket;

FIG. 9 is a side view of the optical pickup unit of an embodiment of the invention;

FIG. 10 is a side view of the optical pickup unit with a slanted motor;

FIG. 11 is a plan view of another optical pickup unit of an embodiment of the invention;

FIG. 12 is a plan view of the optical pickup unit of an embodiment of the invention;

FIG. 13 is a side view of the optical pickup unit of an embodiment of the invention;

FIG. 14 is an exploded perspective view of a previous disk drive unit;

FIG. 15 is a plan view of a previous optical pickup unit; and

FIG. 16 is a side view of the previous optical pickup unit.

### DETAILED DESCRIPTION OF THE INVENTION

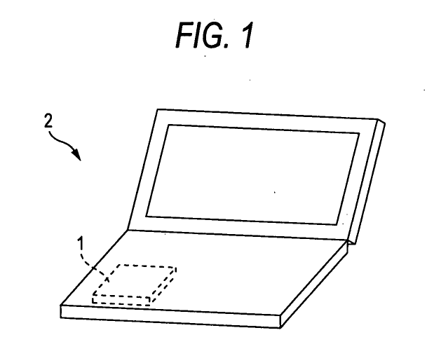

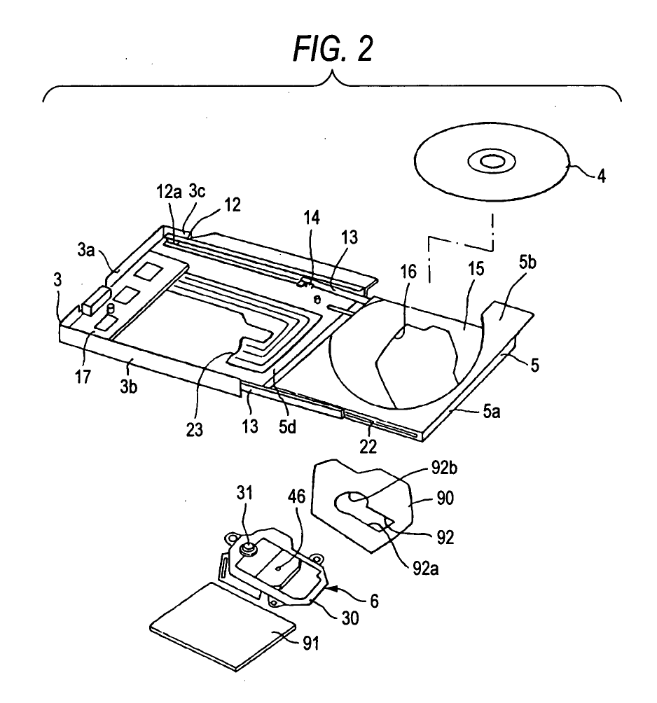

In the below, by referring to the accompanying drawings, a detailed description is made for an optical pickup unit and a disk drive unit to which the invention is applied. A disk drive unit 1 is specifically for reproduction of an optical disk such as CD (Compact Disc), DVD (Digital Versatile Disc), and BD (Blu-ray Disc). As shown in FIG. 1, the disk drive unit 1 is mounted to a drive bay of a host device 2 such as notebook personal computer. As shown in FIG. 2, the disk drive unit 1 is configured to include a unit body 3, a disk tray 5, and an optical pickup unit 6. The unit body 3 serves as an outer cabinet for mounting to the drive bay, and the disk tray 5 is disposed inside of the unit body 3, and carries thereon an optical disk 4 such as DVD. The optical pickup unit 6 is connected to the disk tray 5, and performs reproduction of an information signal with respect to the optical disk 4 placed on the disk tray 5.

The unit body 3 is shaped like substantially a rectangular box, and the front and upper surfaces are left open for insertion and removal of the disk tray. The unit body 3 is made of a metal plate or others by stamping, and then is formed with holes or others. The unit body 3 is provided with a circuit board 17, which is formed with a connection connector or others for establishing connections with a control circuit and the host device 2. The control circuit here is the one exercising drive control over the disk drive unit 1. The unit body 3 is also formed with a rear wall 3a, and side walls 3b and 3c to stand at the side edge portions with the rear wall 3a disposed therebetween. The rear wall 3a is formed on the side opposing the front surface, from which the disk tray 5 is pulled outside of the unit body 3.

The opposing side walls 3b and 3c are each formed with a guide rail 12 from the side of the rear wall 3a toward the open end for guiding the disk tray 5 to be inserted to or removal from the unit body 3. The guide rail 12 is shaped like substantially a square bracket in cross section, and a bracket-shaped (concave) portion 12a is disposed to face toward the side of the unit body 3. In this guide rail 12, the concave portion 12a is engaged with a guide member 13 to be able to freely slide. The guide member 13 is being connected to the disk tray 5. The guide rail 12 is formed with a stopper piece 14 for restricting the area for the guide member 13 to slide, i.e., for preventing the disk tray 5 from being pulled out longer than necessary from the unit body 3. The guide member 13 to be engaged with such a guide rail 12 is also shaped substantially like a square bracket in cross section, and pinches the side surface portions of the disk tray 5 to allow it to slide. When the disk tray 5 is pulled out from the unit body 3 or inserted thereinto, the guide member 13 moves the guide rails 12 to slide so that the disk tray 5 can be moved in a smooth manner.

A wiring board 17 disposed in the vicinity of the rear wall 3a of the unit body 3 is a so-called rigid substrate. The wiring board 17 is formed with a wiring pattern, and is provided thereon with various types of electronic components such as connectors for connection establishment with any external devices. The wiring board 17 is attached with an FPC (Flexible Printed Circuit) 23 being connected to the optical pickup unit 6, which will be described later.

When such a unit body 3 is incorporated into the drive bay of the host device 2, the components on the side of the host device 2, e.g., the rear surface of a keyboard, are located on the side of the open upper surface. With the upper surface left open in the unit body 3 as such, i.e., with no top provided, the thickness of the unit can be reduced to a further extent.

The disk tray 5 to be inserted to and removed from the unit body 3 is made of a material having rigidity such as PPE (polyphenylene ether) with 20% of glass, for example. The disk tray 5 is formed with a housing concave section 15 for accommodating therein the optical disk 4. The housing concave section 15 is substantially a circular concave portion of substantially the same size as the optical disk 4, and thereon, the optical disk 4 is placed with the signal recording surface downward. The housing concave section 15 is formed with, on the main surface portion, an aperture section 16 from which a disk table 31 and an objective lens 46 are faced to the side of the optical disk 4. The disk table 31 and the objective lens 46 are those provided to the optical pickup unit 6, which is attached to the disk tray 5. The aperture section 16 is extended from substantially the center portion of the housing concave section 15 toward the side of a front surface 5a of the disk tray 5. From such an aperture section 16, the disk table 31 and the objective lens 46 that have been exposed upward via a cover member 90 are exposed this time to the side of the signal recording surface of the optical disk 4. The cover member 90 is the one being attached to a base chassis 30 of the optical pickup unit 6.

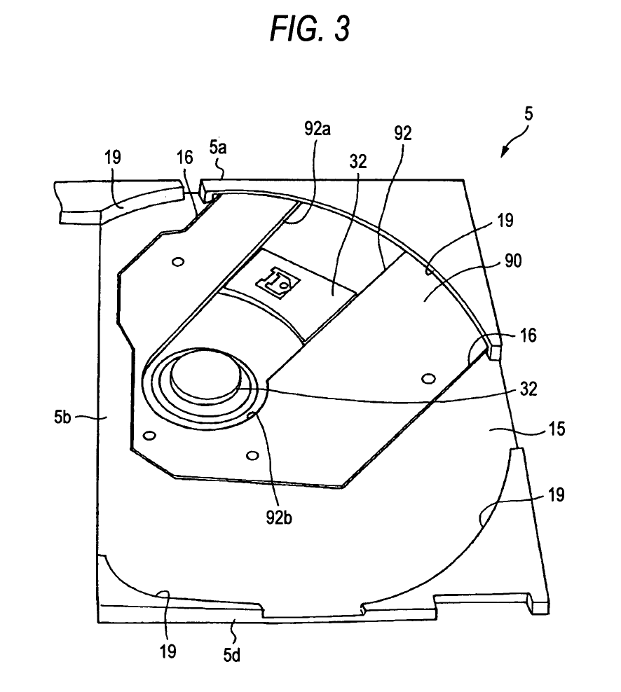

As shown in FIG. 3, the housing concave section 15 is formed therearound with a substantially-arc-shaped housing wall 19. The housing wall 19 is provided for guiding the optical disk 4 to the center of the housing concave section 15, and for preventing the optical disk 4 from falling off from the disk tray 5. For fulfilling the purpose, the housing concave section 15 is formed with a tapered plane on the inner wall side.

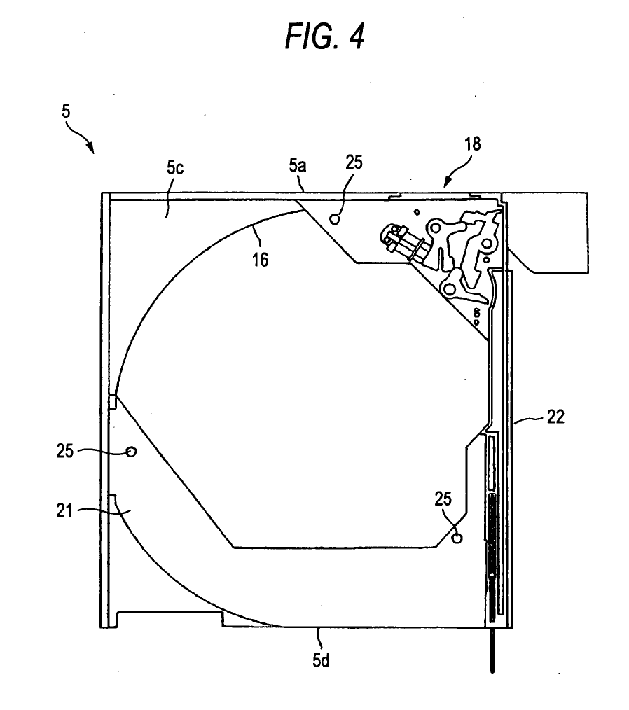

As shown in FIG. 4, the disk tray 5 is formed with a retention mechanism 18 on the side of a rear surface 5c, which is located opposite to the side of a main surface 5b where the housing concave section 15 is provided. The retention mechanism 18 serves to keep hold of, through engagement, a housing section 21 and the disk tray 5 inside of the unit body 3. In the housing section 21, the optical pickup unit 6 (will be described later) is housed. The housing section 21 is formed with a plurality of engagement protrusions 25 for engagement with the optical pickup unit 6. The engagement protrusions 25 are engaged with a plurality of engagement holes 44 formed to the base chassis 30 of the optical pickup unit 6 so that the housing section 21 is attached with the optical pickup unit 6.

The disk tray 5 is formed with a guide protruding thread 22 for engagement with a guide member 13 across the direction of insertion to and removal from the unit body 3. The guide protruding thread 22 is pinched by the above-described guide member 13 to be able to freely slide, thereby guiding the insertion to and removal from the unit body 3. The guide protruding thread 22 is provided with a stopper piece, which is not described in detail, at one end portion on the side of a rear surface 5d, i.e., side of the unit body 3, and at one end portion on the side of the front surface 5a from which the disk tray 5 is pulled out. With the stopper pieces provided as such, the disk tray 5 is prevented from falling off from the guide member 13, and the guide member 13 is prevented from abutting the side of the front surface 5a.

Although not described in detail, the retention mechanism 18 serving to keep hold of the disk tray 5 inside of the unit body 3 may be configured to include a hook, a biasing member, and a control mechanism, for example. With this being the configuration, the hook is to be engaged with an engagement pin provided upright from the unit body 3, for example, the biasing member serves to bias the disk tray 5 toward the outside of the unit body 3, and the control mechanism exercises control over the engagement and detachment between the hook and the engagement pin. When the optical disk 4 is placed on the disk tray 5, and when a user pushes such a disk tray 5 into the unit body 3, the hook is engaged with the engagement pin so that the retention mechanism 18 keeps hold of the disk tray 5 inside of the unit body 3 irrespective of the biasing force of the biasing member. When an ejection signal comes from the host device 2, the retention mechanism 18 releases the engagement between the hook and the engagement pin, and pushes the disk tray 5 to outside of the unit body 3 by the biasing force of the biasing member.

Described next is the optical pickup unit 6 that is to be incorporated inside of the housing section 21 provided on the side of the rear surface 5c of the disk tray 5.

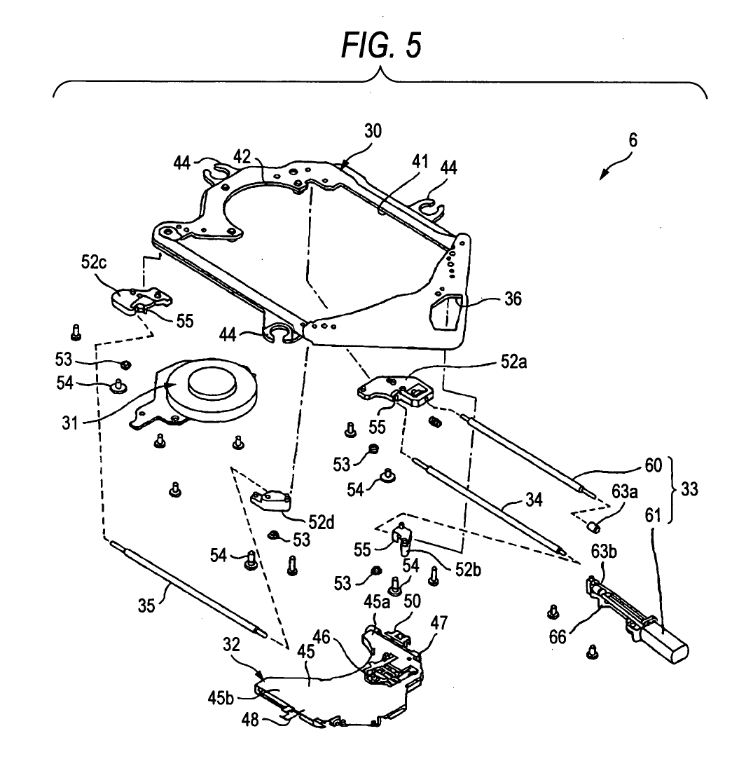

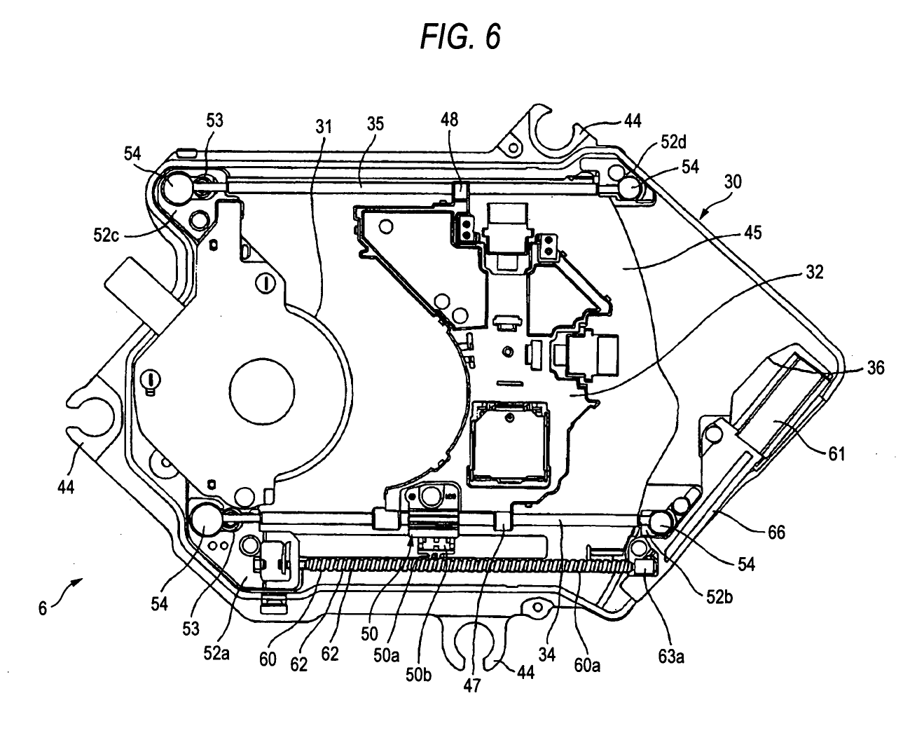

As shown in FIGS. 5 and 6, the optical pickup unit 6 is configured to include the base chassis 30 configuring the unit body, the disk table 31, an optical pickup device 32, a pickup transfer mechanism 33, and a pair of guide shafts 34 and 35. The disk table 31 is formed as a piece with the base chassis 30 and thereon, the optical disk 4 is placed. The optical pickup device 32 performs recording or reproduction of an information signal with respect to the optical disk 4 placed on the disk table 31. The pickup transfer mechanism 33 moves the optical pickup device 32 across the diameter direction of the optical disk 4. The guide shafts 34 and 35 serve to guide the movement of the optical pickup device 32 by the pickup transfer mechanism 33.

The base chassis 30 is a metal-made substantially-rectangular frame body. The base chassis 30 is formed with an aperture section 41 from which the objective lens 46 of the optical pickup device 32 is exposed to the side of the signal recording surface of the optical disk 4. The aperture section 41 is shaped substantially like a rectangle, and is formed with a substantially-arc-shaped notch section 42 on one end side in the longitudinal direction. The base chassis 30 is so disposed that the pair of guide shafts 34 and 35 are extended in the longitudinal direction of the aperture section 41, and the optical pickup device 32 supported by the guide shafts 34 and 35 is laid across the aperture section 41. The notch section 42 of the aperture section 41 is provided with the circular-shaped disk table 31 for placement of the optical disk 4 thereon, and a spindle motor for rotate-driving the disk table 31.

The base chassis 30 is formed with a motor-use aperture section 36 from which a feed motor 61 (will be described later) is exposed upward. As will be described later, from the motor-use aperture section 36, the upper portion of the feed motor 61 is protruded, thereby favorably reducing the unit thickness of the optical pickup unit 6.

The base chassis 30 is formed with a plurality of engagement holes 44 for engagement with a plurality of engagement protrusions 25 formed inside of the housing section 21 on the rear surface 5c of the disk tray 5. The base chassis 30 is housed in the housing section 21 by the engagement holes 44 being respectively engaged with the engagement protrusions 25 via a dumper that is not shown.

The optical pickup device 32 performing recording or reproduction of an information signal with respect to the optical disk 4 placed on the disk table 31 is provided with a pickup base 45, which is a substantially-rectangular cabinet. This pickup base 45 is provided with, at least, a light source such as semiconductor laser (not shown), the objective lens 46, a photodetector (not shown), and a drive system. The objective lens 46 makes light beams coming from the light source converge on the signal recording surface of the optical disk 4 for irradiation. The photodetector detects the reflected lights from the recording surface of the optical disk 4. The drive system serves to drive the objective lens 46 in the directions of focusing and tracking of the optical disk 4. The optical pickup device 32 is formed with an insertion hole 47 on the side of one end 45a in the longitudinal direction of the pickup base 45 for insertion of the guide shaft 34 (will be described later). At the other end 45b, an engagement piece 48 is formed for engagement with the guide shaft 35 (will be described later). The pickup base 45 is attached with the FPC 23, which is formed with a drive circuit or others for control application over the drive system of the objective lens 46.

The optical pickup device 32 is provided adjacent to the guide shaft 34, and is formed with a rack member 50 for engagement with a lead screw 60 of the pickup transfer mechanism 33 that moves the pickup base 45.

The optical pickup device 32 is supported by a pair of guide shafts 34 and 35 disposed at the opposing side edge portions of the aperture section 41 of the base chassis 30. Through such supporting, the optical pickup device 32 is guided for the movement across the optical disk 4, and the objective lens 46 is made to face the signal recording surface of the optical disk 4 from the aperture section 41.

The guide shafts 34 and 35 serving to guide the movement of the optical pickup device 32 are so disposed as to face the aperture section 41 of the base chassis 30 by being supported by housings 52a to 52d at both end portions. The housings 52a to 52d are those attached to the rear surface of the frame 40. The guide shafts 34 and 35 are each tapered to the end portions, and the tapered end portions are supported by a skew adjustment mechanism 51 provided inside of a housing 52. The skew adjustment mechanism 51 adjusts the skew of the optical pickup device 32 in the vertical direction.

As shown in FIGS. 5 and 6, the skew adjustment mechanism 51 is provided at four positions, i.e., the end portions of the guide shaft 34 and the end portions of the guide shaft 35. These skew adjustment mechanisms 51 are each provided with first to fourth housings 52a to 52d, respectively, formed to the rear surface of the frame 40, and are each provided with a conical coil spring 53, and an adjustment screw 54. The conical coil spring 53 is provided inside of each of the housings 52 for biasing the guide shafts 34 and 35, and the adjustment screw 54 is provided on the side opposite to the conical coil spring 53 via the guide shaft 34 or 35 for pressing the guide shaft 34 or 35 from the side opposite to the conical coil spring 53.

The first to fourth housings 52a to 52d are screwed to the base chassis 30 at four corners of the aperture section 41. The first to fourth housings 52a to 52d are each formed with an insertion port 55 for insertion of an end portion of the guide shaft 34 or 35. The housings 52a to 52d are each housing the conical coil spring 53 for biasing the guide shaft 34 or 35, and are each inserted with the adjustment screw 54. The adjustment screw 54 is being inserted into a screw hole drilled to the base chassis 30 from the rear surface side.

The conical coil spring 53 is so disposed that the side of a smaller-diameter tip end comes in contact with the rim surface of the guide shaft 34 or 35, and the side of a larger-diameter tip end 126b comes in contact with the upper wall of the housing 52. As to the adjustment screw 54, the bearing surface of the screw head is made to abut the rim surface of the guide shaft 34 or 35 from the side opposite to the side against which the conical coil spring 53 is abutting.

Through rotation of the adjustment screws 54, the skew adjustment mechanisms 51 adjust the height of the guide shafts 34 and 35 by the bearing surfaces of the screw heads so that the optical pickup unit 6 is subjected to skew adjustment. Note here that, when the guide shafts 34 and 35 are pressed by the adjustment screws 54, the conical coil springs 53 are compressed as are sandwiched between the guide shafts 34 and 35 and the inner wall of the housing 52, i.e., the small-diameter tip ends abutting the guide shafts 34 and 35 dig inside of the large-diameter tip ends.

The rack member 50 serving to move the pickup base 45 along the guide shafts 34 and 35 is screwed to the pickup base 45 at one end, and is engaged with a screw grooves 62 formed to a shaft portion 60a of the lead screw 60 at the other end, thereby moving along the shaft portion 60a and converting the rotation movement of the lead screw 60 into the linear movement.

As shown in FIG. 6, the rack member 50 is configured to include a pair of engagement protrusion portions 50a and a housing portion 50b. The engagement protrusion portions 50a are each engaged with the screw grooves 62 of the lead screw 60, and the housing portion 50b carries therein a biasing member for biasing the engagement protrusion portions 50a to the side of the screw grooves 62 of the lead screw 60. The rack member 50 is disposed to face the shaft portion 60a of the lead screw 60 from the pickup base 45 in such a manner as to lie across the guide shaft 34. With such a disposition, the engagement protrusion portions 50a are engaged with the screw grooves 62 of the shaft portion 60a. The engagement protrusion portions 50a are those protruded from the housing wall of the housing portion 50b, which is pressed against the biasing member.

As shown in FIG. 6, the pickup transfer mechanism 33 moving the optical pickup device 32 across the diameter direction of the optical disk 4 is configured to include the lead screw 60 and the feed motor 61. The lead screw 60 is attached to the base chassis 30 to be adjacent and parallel to the guide shaft 34, and the feed motor 61 serves to rotate-drive the lead screw 60.

The lead screw 60 is supported, at one end of the shaft portion 60a formed with the screw grooves 62, by the first housing 52a to be able to freely rotate. The other end of the shaft portion 60a is supported by a motor bracket 66 of the feed motor 61 (will be described later). As such, the lead screw 60 is supported to be parallel to the guide shaft 34 at substantially the same height as the guide shaft 34 with respect to the optical disk 4. The lead screw 60 is engaged with, at the shaft portion 60a, the rack member 50 provided to the pickup base 45. By being rotate-driven by the feed motor 61, the lead screw 60 can move the pickup base 45 across the diameter direction of the optical disk 4 via the rack member 50.

The lead screw 60 is attached with, at the other end side supported by the motor bracket 66, a screw gear 63a for engagement with a motor shaft 65 of the feed motor 61. The lead screw 60 receives the rotation force from the motor shaft 65 via the screw gear 63a, and is rotate-driven in one or the other direction.

The feed motor 61 for rotate-driving the lead screw 60 is a thread motor, and is exemplified by a stepping motor and a direct current motor. When the feed motor 61 is a stepping motor, the lead screw 60 is rotate-driven by rectangular waves through step feeding, thereby moving the pickup base 45 across the diameter direction of the optical disk 4.

In the feed motor 61, the motor shaft 65 is disposed not parallel to the shaft portion 60a of the lead screw 60. With such a disposition, the feed motor 61 is never so disposed that the longitudinal direction thereof is directed to the axial direction of the lead screw 60. As such, the area of the base chassis 30 can be used with efficiency so that the optical pickup unit 6 can be favorably reduced in size.

The tip end portion of the motor shaft 65 is attached with a screw gear 63b, and a screw gear 63b is engaged with the screw gear 63a so that the feed motor 61 is coupled with the shaft portion 60a of the lead screw 60. To be specific, the lead screw 60 and the feed motor 61 are both supported, at the other end of the shaft portion 60a and the tip end of the motor shaft 65, by the motor bracket 66 to be able to freely rotate. Through such supporting, the screw gears 63a and 63b respectively attached to the shaft portion 60a and the motor shaft 65 are engaged with each other.

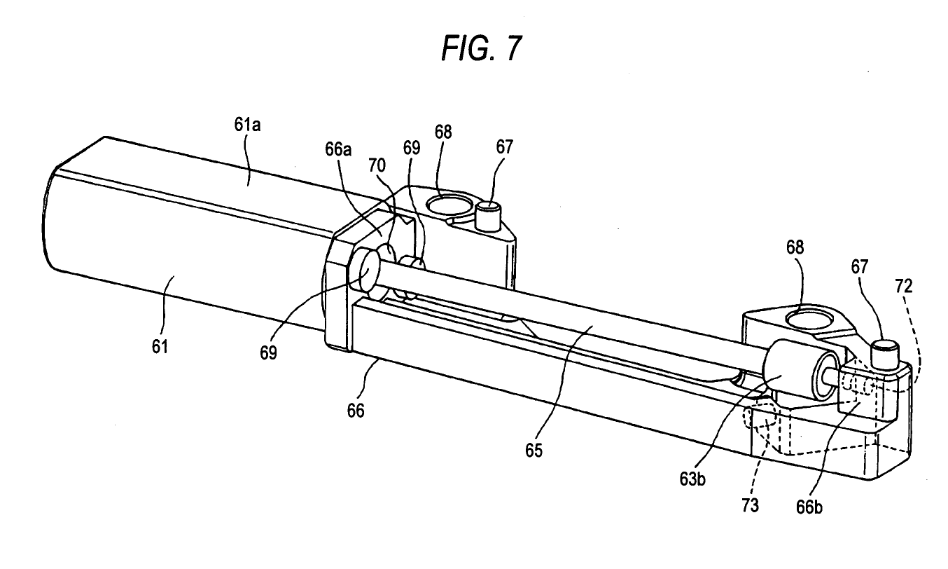

As shown in FIG. 7, the motor bracket 66 is a rod-like molded member, and at one end in the longitudinal direction, a side wall 66a is formed for attachment of a motor housing 61a of the feed motor 61. At the other end in the longitudinal direction, a bearing portion 66b is formed for supporting the motor shaft 65 and the shaft portion 60a of the lead screw 60. The motor bracket 66 is formed with, at one side in the longitudinal direction, an engagement protrusion section 67 for engagement with an engagement hole drilled to the base chassis 30, and at the other side, a screw hole 68 for screw fastening to the base chassis 30.

The side wall 66a is formed with a screw hole, and is connected with the motor housing 61a by a screw 69. The side wall 66a is formed with an aperture section 70 for insertion of the motor shaft 65 being a protrusion from the motor housing 61a. The motor shaft 65 being inserted into the aperture section 70 is supported by, through insertion, a motor shaft hole 72 of the bearing portion 66b formed at the other end of the motor bracket 66.

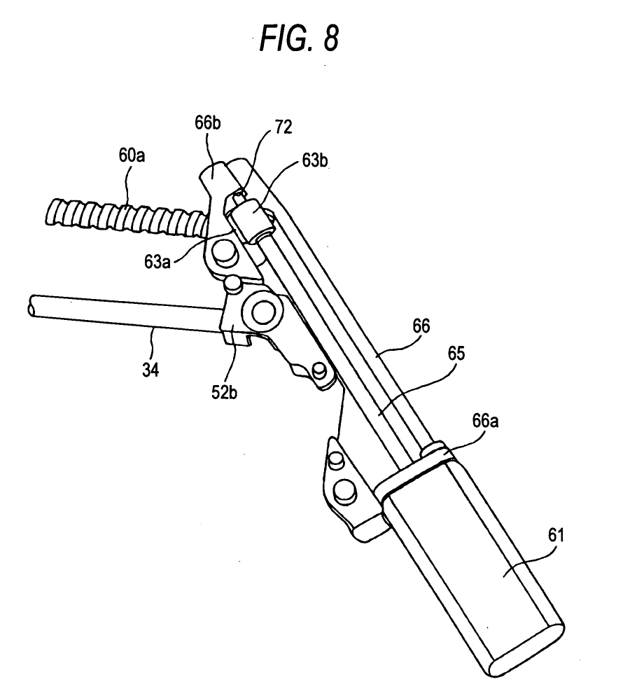

The bearing portion 66b is formed with, on the side surface opposing the side wall 66a, a motor shaft hole 72 for supporting the tip end of the motor shaft 65. The bearing portion 66b is also formed with a lead-screw shaft hole 73 for supporting the tip end of the shaft portion 60a. The lead-screw shaft hole 73 is formed on the plane of the axial direction of the shaft portion 60a of the lead screw 60 when the bearing portion 66b is attached to the base chassis 30. The motor shaft hole 72 is formed at the height different from that of the lead-screw shaft hole 73, and as shown in FIG. 8, the motor shaft 65 is so supported as to three-dimensionally cross the shaft portion 60a of the lead screw 60. The motor shaft 65 and the lead screw 60 are supported by the motor bracket 66 so that the screw gears 63a and 63b respectively attached to the motor shaft 65 and the shaft portion 60a are engaged with each other.

Such a motor bracket 66 is fixed to the rear surface side of the base chassis 30 by the engagement protrusion section 67 being engaged with the engagement hole drilled to the base chassis 30, and being screwed to the base chassis 30 via the screw hole 68. At this time, the upper portion of the feed motor 61 is exposed upward from the motor-use aperture section 36 drilled to the base chassis 30, and the upper surface thereof will be substantially the same height as the base chassis 30 or be protruded from the upper surface of the base chassis 30.

In such a pickup transfer mechanism 33, when the pickup base 45 is driven by the host device 2, the feed motor 61 under the servo control by a microprocessor of the host device 2 rotate-drives the motor shaft 65 by a predetermined number of times. Accordingly, the shaft portion 60a of the lead screw 60 attached with the screw gear 63a is rotated by the predetermined number of times via the screw gear 63b attached at the tip end of the motor shaft 65. In response to such rotations, the rack member 50 engaged with the shaft portion 60a is moved along the shaft portion 60a, and the pickup base 45 is transferred across the diameter direction of the optical disk 4.

As shown in FIG. 6, such an optical pickup unit 6 is reduced in thickness in its entirety by the feed motor 61 and the motor bracket 66 being disposed outside of the projection plane of the optical disk 4 being chucked to the disk table 31. That is, for keeping hold of the optical disk 4 to allow it freely rotate, the optical pickup unit 6 has to have any space of a predetermined size above the optical disk 4, whereby the entire unit is defined by the upper limit. With the previous optical pickup unit, the feed motor being the impediment to thickness reduction has been disposed below the optical disk so that the entire unit is defined by the lower limit by the position of the lower surface of the feed motor 61. As a result, the previous optical pickup unit has been bulky in its entirety due to the thickness of the feed motor in addition to the space defined as being required for keeping hold of the optical disk 4.

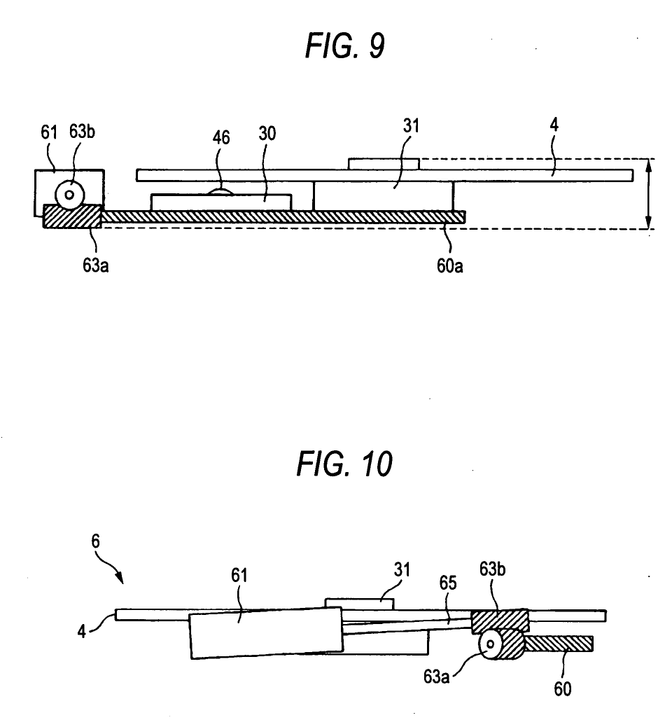

On the other hand, in the optical pickup unit 6, as shown in FIGS. 6 and 9, the feed motor 61 required to be thick to a certain extent is disposed outside of the projection plane of the optical disk 4, i.e., not disposed below the optical disk 4. With such a configuration, the feed motor 61 that has defined the lower limit of the entire unit can be disposed at the upper portion of the base chassis 30, i.e., outside of the projection plane of the optical disk 4 where the space is ample. This configuration accordingly shifts upward the lower portion of the optical pickup unit 6 in its entirety so that the thickness reduction can be entirely achieved. In the optical pickup unit 6, with the feed motor 61 moved upward as such, the component being the determination factor of the lower thickness limit of the entire unit is not the feed motor 61 any more but any other component, e.g., the screw gear 63a attached to the shaft portion 60a of the lead screw 60. As such, the feed motor 61 that has been the impediment to thickness reduction is not responsible for the thickness of the unit, thereby favorably reducing the thickness of the entire unit.

Note here that the feed motor 61 never goes beyond any defined space above the optical disk 4 even if it is disposed outside of the projection plane of the optical disk 4, thereby not affecting the upper limit of the entire unit.

Even if the bulky feed motor 61 is adopted for use, the optical pickup unit 6 is not increased in thickness thereby if the motor is not exceeding any space defined on the optical space 4. Therefore, the optical pickup unit 6 can adopt the feed motor 61 that can produce any necessary torque sufficient in amount.

With the thickness reduction achieved for the optical pickup unit 6 as such, in the disk drive unit 1, the disk tray 5 can be also reduced in thickness because the optical pickup unit 6 for housing therein is reduced in thickness as such, and by extension, the unit body 3 can be also reduced in thickness because the disk tray 5 therefor is reduced in thickness as such.

In the optical pickup unit 6, the motor shaft 65 and the shaft portion 60a of the lead screw 60 are supported by the motor shaft hole 72 and the lead-screw shaft hole 73 formed to the bearing portion 66b of the motor bracket 66. Through such supporting, in the optical pickup unit 6, the screw gears 63a and 63b respectively attached to the motor shaft 65 and the shaft portion 60a of the lead screw 60 can be engage with each other with good accuracy. As such, the rotation force of the feed motor 61 can be transferred to the lead screw 60 without fail.

On the other hand, when the motor shaft 65 and the shaft portion 60a of the lead screw 60 are supported by each different bearing member, the screw gears 63a and 63b cannot be engaged with each other with good accuracy due to any possible variations observed between the shafts caused by deviations of the bearing members in terms of product accuracy and assembly accuracy. As a result, the rotation force of the feed motor 61 cannot be transferred to the lead screw 60 with high degree of efficiency.

As such, in the optical pickup unit 6, the motor shaft hole 72 and the lead-screw shaft hole 73 are formed by molding to the bearing portion 66b of the motor bracket 66 for supporting thereby the motor shaft 65 and the shaft portion 60a of the lead screw 60. Through such supporting, the screw gears 63a and 63b can be engaged with each other with good accuracy.

As shown in FIGS. 2 and 3, in such an optical pickup unit 6, the cover member 90 is screwed to the side of the upper surface of the base chassis 30, and to the side of the lower surface, a bottom plate 91 is screwed to the disk tray 5. With such screwing, the optical pickup unit 6 is sandwiched by the cover member 90 and the bottom plate 91.

The cover member 90 is formed with an aperture section 92 from which the objective lens 46 and the disk table 31 formed to the optical pickup device 32 are exposed upward. The aperture section 92 includes a rectangular aperture portion 92a and a circular aperture portion 92b in accordance with the area allowed for the pickup base 45 to move. The rectangular aperture section 92a is formed substantially like a rectangle from the inner radius to the outer rim of the optical disk 4, and the circular aperture portion 92b is formed substantially like a circle to be in a row with the inner side edge portion of the rectangular aperture portion 92a in accordance with the disk table 31.

As shown in FIG. 3, when the base chassis 30 is housed in the housing section 21 of the disk tray 5, the cover member 90 is faced to the side of the optical disk 4 from the aperture section 16 of the disk tray 5, and configures a part of the housing concave section 15. As is screwed to the base chassis 30, the cover member 90 comes in close contact with the side of the base chassis 30, and thus is prevented from moving away from the housing concave section 15. As such, the signal recording surface of the optical disk 4 can be protected from damage possibly caused by the main surface of the cover member 90 and the aperture end of the aperture section 92.

The bottom plate 91 is made of an aluminum plate by stamping. The bottom plate 91 is formed with a predetermined screw hole, and is screwed to the housing section 21 from the bottom surface side of the base chassis 30 housed in the housing section 21 of the disk tray 5. Through such screwing, the base chassis 30 is pinched thereby and is connected to the disk tray 5.

As shown in FIG. 10, with the optical pickup unit 6 to which the invention is applied, the feed motor 61 and the motor shaft 65 may be disposed, if required, with a skew toward the axial direction of the lead screw 60. If this is the configuration, as described above, in addition to the thickness reduction achieved in the above for the entire unit, i.e., the feed motor 61 is disposed out of the projection plane of the optical disk 4 and is disposed to the upper portion of the base chassis 30, thereby bringing the lower limit of the feed motor 61 to substantially the same height as the screw gear 63a attached to the shaft portion 60a of the lead screw 60, for example, some space is secured above the feed motor 61, and the housing wall 19 of the disk tray 5 located above the feed motor 61 is of any desired thickness so that the rigidity thereof can be secured.

Herein, the shaft portion 60a of the lead screw 60 coupled to the motor shaft 65 is provided for coupling with the pickup base 45 of the optical pickup unit 6 via the rack member 50, and for transferring the pickup base 45 along the guide shafts 34 and 35. As such, the shaft portion 60a is disposed in the projection plane of the optical disk 4, and is preferably disposed parallel to the guide shaft 34 at substantially the same height considering the configuration that the rack member 50 is placed across the guide shaft 34 and thus is faced the shaft portion 60a of the lead screw 60, and the engagement protrusion portion 50a is biased against the screw groove 62 of the lead screw 60 by the biasing member disposed to the housing portion 50b.

As such, as to the optical pickup unit 6, it is difficult to change the height of the shaft portion 60a of the lead screw 60 in accordance with the position change of the feed motor 61, but by placing the feed motor 61 with a skew, the coupling can be established with the shaft portion 60a of the lead screw 60. Note here that, because the motor shaft 65 and the shaft portion 60a of the lead screw 60 are coupled together via the screw gears 63a and 63b, even if the feed motor 61 is disposed with a skew as such, the engagement between the screw gears 63a and 63b can be established with no problem.

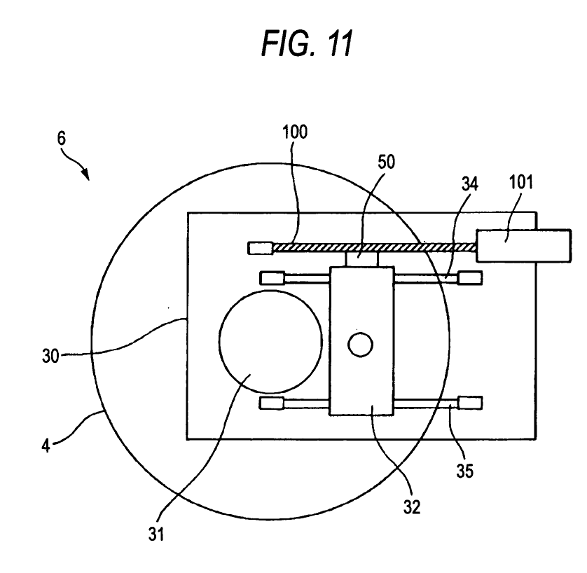

As shown in FIG. 11, in the optical pickup unit 6 to which the invention is applied, a feed motor 101 may be attached to one end portion of a lead screw 100, and the lead screw 100 may be rotate-driven directly by the feed motor 101. Also in this case, in the optical pickup unit 6, the bulky feed motor 101 is disposed out of the projection plane of the optical disk 4. Accordingly, the feed motor 101 that has been defined the lower limit of the thickness of the entire unit can be disposed to the upper portion of the base chassis 30, i.e., outside of the projection plane of the optical disk 4 where the space is ample. This configuration accordingly shifts upward the lower limit of the unit in its entirety so that the thickness reduction can be entirely achieved.

Note here that the configuration of including the feed motor 101 on the axis of the lead screw 100 can be applied when the space is ample in the base chassis 30 along the axial direction of the lead screw 100.

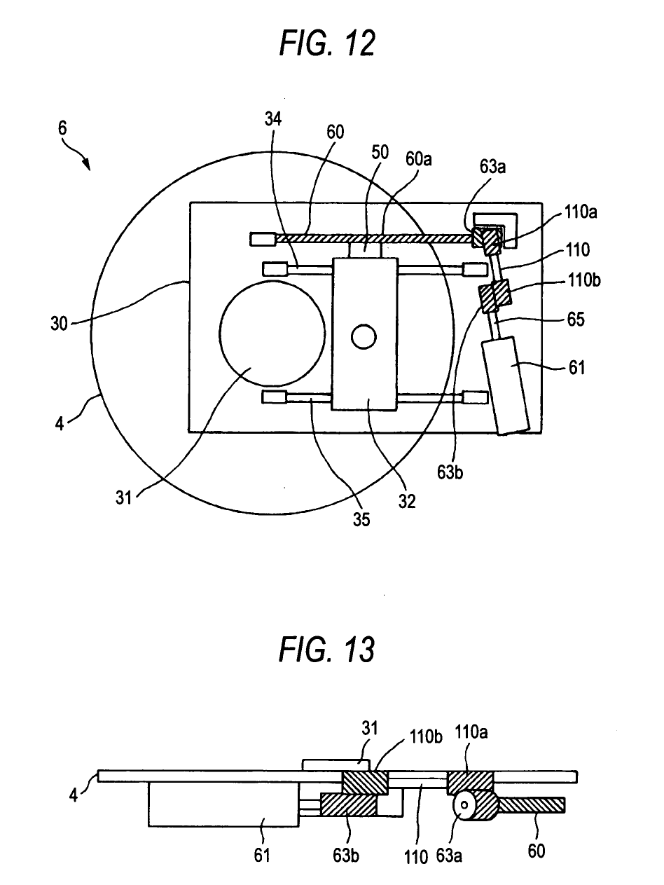

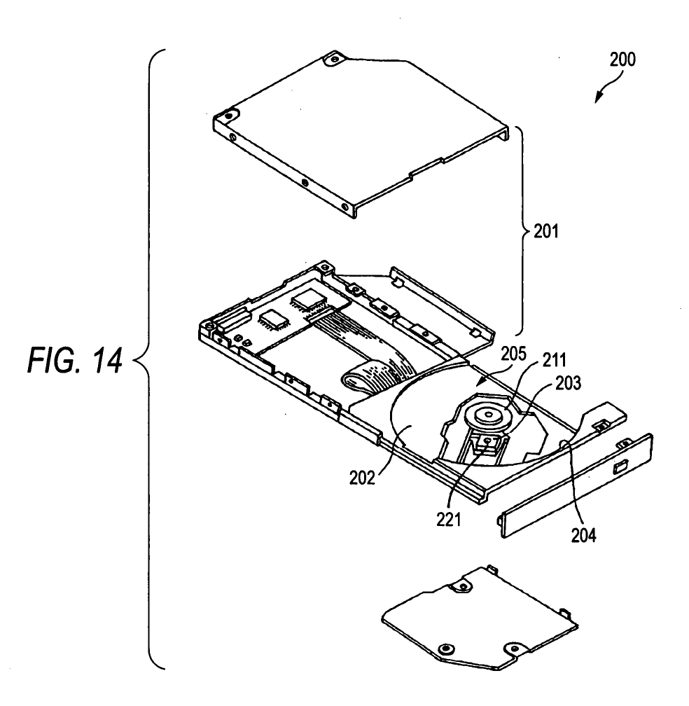

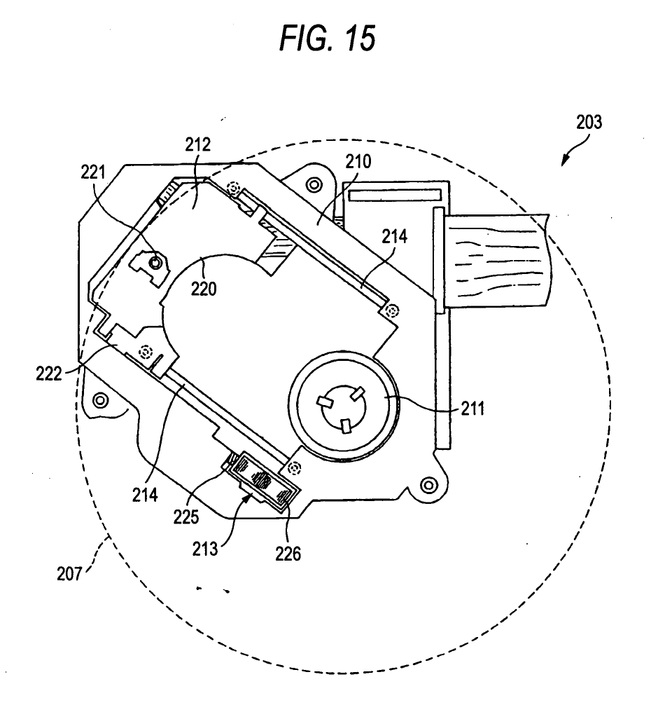

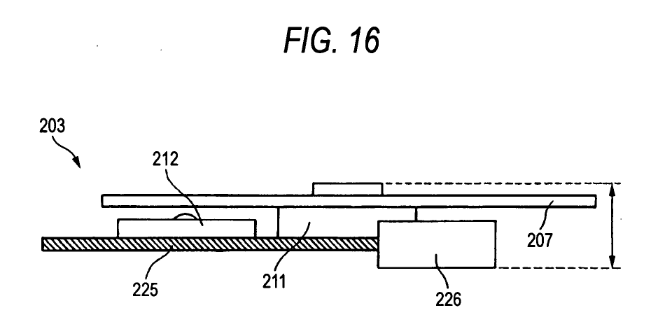

As shown in FIGS. 12 and 13, in the optical pickup unit 6 to which the invention is applied, the shaft portion 60a of the lead screw 60 may be coupled to the motor shaft 65 of the feed motor 61 via a relay shaft 110. The relay shaft 110 is attached with, at one end, a first relay screw gear 110a for engagement with the screw gear 63a attached to the shaft portion 60a, and at the other end, a second relay screw gear 110b for engagement with the screw gear 63b attached to the motor shaft 65.

As shown in FIG. 12, the relay shaft 110 is disposed from the shaft portion 60a of the lead screw 60 being adjacent to the guide shaft 34 toward the side of the guide shaft 35, and the feed motor 61 and the motor shaft 65 are engaged from the side of the disk table 31. With the relay shaft 110 disposed therebetween as such, the feed motor 61 and the motor shaft 65 are moved to closer to the side of the disk table 31 in the optical pickup unit 6 so that the space of the base chassis 30 can be reduced across the axial direction of the lead screw 60, thereby leading to further size reduction.

Also in this case, in the optical pickup unit 6, the bulky feed motor 61 is disposed out of the projection plane of the optical disk 4. Accordingly, the feed motor 61 that has been defined the lower limit of the thickness of the entire unit can be disposed to the upper portion of the base chassis 30, i.e., outside of the projection plane of the optical disk 4 where the space is ample. This configuration accordingly shifts upward the lower limit of the unit in its entirety so that the thickness reduction can be entirely achieved.

As such, the optical pickup unit and the disk drive unit to which the invention is applied are described as above. However, the invention is surely not restrictive to a disk drive unit of a type transferring the optical disk 4 using the disk tray 5, and is applicable to a disk drive unit equipped with various many types of disk transfer means, e.g., a disk drive unit of a so-called slot-in type automatically transferring the optical disk 4 using a transfer arm.

The invention is not restrictive to a disk drive unit of a type being equipped to a host device, and is applicable to various many types of disk drive unit using an optical disk as a recording/reproduction medium, e.g., portable disk player, built-in disk player, camcorder using an optical disk as a recording medium, and an optical pickup unit of the disk drive unit.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup unit, comprising:
a base chassis;
a disk table mounted to the base chassis for chucking an optical disk to be able to freely rotate;
an optical pickup that records and/or reproduces an information signal with respect to the optical disk;
a guide shaft supported by the base chassis, and guides the optical pickup to move in a diameter direction of the optical disk; and
a pickup transfer mechanism including a lead screw supported parallel to the guide shaft and engaged with the optical pickup via a rack member, and a drive motor for rotate-driving the lead screw, wherein
the drive motor is disposed out of a projection area of, with respect to the base chassis, the optical disk chucked to the disk table.

2. The optical pickup unit according to claim 1, wherein
the drive motor includes a motor shaft that is disposed not parallel to the lead screw, and is coupled to the lead screw via a gear.

3. The optical pickup unit according to claim 2, wherein
the gear is a screw gear.

4. The optical pickup unit according to claim 2, wherein
the motor shaft is disposed with a skew toward an axial direction of the lead screw.

5. The optical pickup unit according to claim 2, wherein
the motor shaft and the lead screw are coupled to each other via a relay shaft.

6. The optical pickup unit according to claim 2, wherein
the motor shaft and the lead screw are supported by any same bearing member.

7. A disk drive unit, comprising:
a base chassis;
a disk table mounted to the base chassis for chucking an optical disk to be able to freely rotate;
an optical pickup that records and/or reproduces an information signal with respect to the optical disk;
a guide shaft supported by the base chassis, and guides the optical pickup to move in a diameter direction of the optical disk; and
a pickup transfer mechanism including a lead screw supported parallel to the guide shaft and engaged with the optical pickup via a rack member, and a drive motor for rotate-driving the lead screw, wherein
the drive motor includes an optical pickup unit disposed out of a projection area of, with respect to the base chassis, the optical disk chucked to the disk table.

8. The disk drive unit according to claim 7, wherein
the drive motor includes a motor shaft that is disposed not parallel to the lead screw, and is coupled to the lead screw via a gear.

9. The disk drive unit according to claim 8, wherein
the gear is a screw gear.

10. The disk drive unit according to claim 8, wherein
the motor shaft is disposed with a skew toward an axial direction of the lead screw.

11. The disk drive unit according to claim 8, wherein
the motor shaft and the lead screw are coupled to each other via a relay shaft.

12. The disk drive unit according to claim 8, wherein
the motor shaft and the lead screw are supported by any same bearing member.

13. The disk drive unit according to claim 7, further comprising
a disk tray provided across a unit body to be attachable/detachable, wherein
the optical pickup unit is mounted to the disk tray.
